(19) United States
(12) Patent Application Publication
(10) Pub. No.: US 2019/0036793 A1
(43) Pub. Date: Jan. 31, 2019

(54) NETWORK SERVICE IMPLEMENTATION METHOD, SERVICE CONTROLLER, AND COMMUNICATIONS SYSTEM

(71) Applicant: Huawei Technologies Co., Ltd., Shenzhen (CN)

(72) Inventors: Jingwang Ma, Shanghai (CN); Yuan Wang, Shanghai (CN); Fenqin Zhu, Shanghai (CN)

(21) Appl. No.: 16/144,730

(22) Filed: Sep. 27, 2018

Related U.S. Application Data
(63) Continuation of application No. PCT/CN2016/077465, filed on Mar. 28, 2016.

(51) Int. Cl. H04L 12/24

(52) U.S. Cl. CPC H04L 41/5054

(57) ABSTRACT

The present application provides a network service implementation method, a service controller, and a communications system. The method includes: receiving a service request message including a message identifier; determining, based on the service request message, a target service component corresponding to the message identifier; and determining a target service instance from at least one service instance of the target service component, and sending the service request message to the target service instance, so that the target service instance processes the service request message. The present application is used to improve efficiency in providing a network service.

### CROSS-REFERENCE TO RELATED APPLICATIONS

This application is a continuation of International Application No. PCT/CN2016/077465 filed on Mar. 28, 2016, the disclosure of which is hereby incorporated by reference in its entirety.

### TECHNICAL FIELD

The present application relates to the field of communications technologies, and in particular, to a network service implementation method, a service controller, and a communications system.

### BACKGROUND

With continuous development of network technologies, a communications system provides more types of network services for a user. For example, the network services may include mobility management, bearer management, location management, and the like.

In the prior art, a plurality of network elements are deployed in a communications system. The network elements may include a mobility management entity (MME), a serving gateway (S-GW), a packet data network gateway (P-GW), and the like. When a network service needs to be implemented in the communications system, processing logic of the plurality of network elements and a procedure of interaction between the plurality of network elements are usually set based on a feature of the network service that needs to be implemented, and the plurality of network elements jointly implement one network service. When a user needs to obtain a network service, the user sends a corresponding service request message to a network side of the communications system. After the network side receives the service request message sent by the user, the network side determines a plurality of network elements corresponding to the service request message, and transfers the service request message between the plurality of network elements. The plurality of network elements successively process the service request message, to complete the network service requested by the user.

However, in the foregoing process, because cooperation between a plurality of network elements is required to complete one network service, when the user requests, by using the service request message, to obtain the network service, the service request message needs to be transferred between the plurality of network elements and processed by the plurality of network elements. This process is complex and takes relatively long duration, resulting in low efficiency in providing the network service by the communications system for the user.

### SUMMARY

Embodiments of the present application provide a network service implementation method, a service controller, and a communications system, to improve efficiency in providing a network service.

According to a first aspect, an embodiment of the present application provides a network service implementation method. The method is performed by a service controller, and the method includes: receiving, by the service controller, a service request message including a message identifier, and determining, based on the received service request message, a target service component corresponding to the message identifier in the service request message. Because each service component includes at least one service instance, after the service controller determines that the target service component is obtained, the service controller determines a target service instance from at least one service instance of the target service component, and sends the service request message to the target service instance, so that the target service instance processes the service request message. In this process, a network service can be provided for a user by using one service instance, and cooperation between a plurality of network elements is not required, so that a quantity of message exchange times is reduced, and time required for providing the network service for the user is shortened, thereby improving efficiency in providing the network service by a communications system for the user.

In a possible design, when a type of the service request message is a trigger message, the trigger message is a message for triggering a network service, and the service controller may determine the target service instance from the at least one service instance of the service component in the following feasible implementations. Specifically:

In a feasible implementation, the service controller determines any one of the at least one service instance as the target service instance. In this feasible implementation, one of the at least one service instance is randomly determined as the target service instance, so that a speed of determining the target service instance by the service controller can be increased.

In another feasible implementation, the service controller obtains idleness of each of the at least one service instance, and determines a service instance with highest idleness as the target service instance. In this feasible implementation, the service instance with the highest idle rate is determined as the target service instance, so that a resource of each service instance can be more effectively used.

In another possible design, the service request message may further include a terminal identifier, and after the service controller sends the service request message to the target service instance, the service controller may further determine and store a first correspondence among the terminal identifier, the target service component, and the target service instance.

In still another possible design, when a type of the service request message is a process message, the process message is a message that is sent by a user after the user sends a trigger message and that is used to obtain a network service, the service request message further includes a terminal identifier, and the service controller may determine the target service instance from the at least one service instance of the service component in the following feasible implementation. Specifically, the service controller obtains a second correspondence among a terminal identifier, a service component, and a service instance, and the service controller determines the target service instance based on the second correspondence, the terminal identifier in the service request message, and the target service component.

In yet another possible design, after the service controller sends the service request message to the target service instance, the service controller may further determine whether the network service ends; and the service controller removes, from the second correspondence, a correspondence among the terminal identifier in the service request message, the target service component, and the target service instance if a determining result is that the network service ends.

In any one of the foregoing possible designs, the service controller may send the service request message to the target service instance in the following feasible implementation. Specifically, the service controller obtains a network address of the target service instance, and sends the service request message to the target service instance based on the network address. Optionally, the network address may include any one or any combination of the following: an Internet Protocol (IP) address, a Media Access Control (MAC) address, and a port number.

According to a second aspect, an embodiment of the present application provides a service controller, and the service controller may include a receiving module, a determining module, and a sending module. The receiving module is configured to receive a service request message, and the service request message includes a message identifier. The determining module is configured to: determine, based on the service request message, a target service component corresponding to the message identifier, and determine a target service instance from at least one service instance of the target service component. The sending module is configured to send the service request message to the target service instance, so that the target service instance processes the service request message.

In a possible design, when a type of the service request message is a trigger message, the determining module is specifically configured to: determine any one of the at least one service instance as the target service instance; or obtain idleness of each of the at least one service instance, and determine a service instance with highest idleness as the target service instance.

In another possible design, the service controller further includes a storage module. The determining module is further configured to determine a first correspondence among a terminal identifier, the target service component, and the target service instance after the sending module sends the service request message to the target service instance, and the service request message further includes the terminal identifier. The storage module is configured to store the first correspondence among the terminal identifier, the target service component, and the target service instance.

In still another possible design, when a type of the service request message is a process message, the determining module is further specifically configured to: obtain a second correspondence among a terminal identifier, a service component, and a service instance; and determine the target service instance based on the second correspondence, a terminal identifier in the service request message, and the target service component.

In yet another possible design, the service controller may further include a judgment module and a removing module. The judgment module is configured to: after the sending module sends the service request message to the target service instance, determine whether a network service ends. The removing module is configured to remove, from the second correspondence, a correspondence among the terminal identifier in the service request message, the target service component, and the target service instance when the judgment module determines that the network service ends.

In any possible design of the second aspect, the sending module is specifically configured to: obtain a network address of the target service instance, and send the service request message to the target service instance based on the network address. Optionally, the network address includes any one or any combination of the following: an IP address, a MAC address, and a port number.

It should be noted that the service controller in any possible design of the second aspect can execute any possible technical solution in the first aspect, implementation principles and beneficial effects thereof are similar, and details are not described herein again.

According to a third aspect, an embodiment of the present application provides a communications system, the communications system includes a service controller and at least one service component, one service component corresponds to one network service, and each service component includes at least one service instance. The service controller is configured to: receive a service request message including a message identifier; determine a target service component corresponding to the message identifier; determine a target service instance from at least one service instance of the target service component; and send the service request message to the target service instance. The service instance is configured to: receive the service request message sent by the service controller, and process the service request message. In the system, a network service can be provided for a user by using one service instance, and cooperation between a plurality of network elements is not required, so that a quantity of message exchange times is reduced, and time required for providing the network service for the user is shortened, thereby improving efficiency in providing the network service by the communications system for the user. Further, when a network service in the communications system needs to be changed (for example, upgrading an existing network service or adding a new network service to the communications system), only a service component corresponding to the network service needs to be changed without a need to change processing logic of a plurality of network elements in the communications system and a procedure of interaction between the plurality of network elements. This process is simple and convenient, and reduces network service maintenance costs.

In a possible design, the system further includes a service deployment center and a service registration center. The service deployment center is configured to: determine a correspondence between a service component in the communications system and a message identifier, and send the correspondence to the service registration center. The service registration center is configured to receive and store the correspondence sent by the service deployment center. Correspondingly, the service controller is configured to: receive the service request message including the message identifier; obtain the correspondence from the service registration center; determine, based on the correspondence, the target service component corresponding to the message identifier; determine the target service instance from the at least one service instance of the target service component; and send the service request message to the target service instance. The service deployment center and the service registration center are deployed in the communications system, and the service deployment center and the service registration center execute different tasks. This further facilitates maintenance of the communications system.

In another possible design, the service deployment center is further configured to: obtain a service requirement corresponding to each service component in the communications system, deploy the at least one service instance for each service component in the communications system based on the service requirement corresponding to each service component, and send the service instance included in each service component and attribute information of each service instance to the service registration center, where the attribute information includes a network address of the service instance. The service registration center is further configured to receive and store the service instance included in each service component and the attribute information of each service instance that are sent by the service deployment center. Correspondingly, the service controller is further configured to: receive the service request message including the message identifier; obtain the correspondence from the service registration center; determine, based on the correspondence, the target service component corresponding to the message identifier; obtain, from the service registration center, the at least one service instance included in the target service component; determine the target service instance from the at least one service instance; and send the service request message to the target service instance.

In still another possible design, the communications system further includes a monitoring module, and the monitoring module is configured to: obtain a working status of the service instance in the communications system, and generate a fault notification message when the working status of the service instance is an abnormal state. The monitoring module monitors the working status of the service instance in the communications system in real time, and feeds back a fault in time, so that reliability of the communications system is effectively enhanced.

According to a fourth aspect, an embodiment of the present application provides a service controller, and the service controller includes a processor, a receive port, a transmit port, a communications bus, and a memory. The communications bus is configured to implement communication connection between components, the memory may store various programs, and the processor completes various processing functions and implements method steps in this embodiment by executing the programs stored in the memory. Specifically:

The processor receives a service request message by using the receive port, where the service request message includes a message identifier; determines, based on the service request message, a target service component corresponding to the message identifier; and determines a target service instance from at least one service instance of the target service component. The processor sends the service request message to the target service instance by using the transmit port, so that the target service instance processes the service request message.

In an actual application process, when a type of the service request message is a trigger message, specifically, the processor may determine the target service instance from the at least one service instance in the following feasible implementation:

determining any one of the at least one service instance as the target service instance; or

obtaining idleness of each of the at least one service instance, and determining a service instance with highest idleness as the target service instance.

In an actual application process, after sending the service request message to the target service instance by using the transmit port, the processor further determines a first correspondence among a terminal identifier, the target service component, and the target service instance, and the service request message further includes the terminal identifier.

The processor stores, in the memory, the first correspondence among the terminal identifier, the target service component, and the target service instance.

In an actual application process, when a type of the service request message is a process message, specifically, the processor may determine the target service instance from the at least one service instance in the following feasible implementation:

obtaining a second correspondence among a terminal identifier, a service component, and a service instance; and

determining the target service instance based on the second correspondence, a terminal identifier in the service request message, and the target service component.

Further, after sending the service request message to the target service instance by using the transmit port, the processor further determines whether a network service ends.

When determining that the network service ends, the processor removes, from the second correspondence, a correspondence among the terminal identifier in the service request message, the target service component, and the target service instance.

Optionally, the processor may send the service request message to the target service instance in the following feasible implementation. Specifically, the processor obtains a network address of the target service instance, and sends the service request message to the target service instance based on the network address, where the network address includes any one or any combination of the following: an IP address, a MAC address, and a port number.

Based on the network service implementation method, the service controller, and the communications system provided in the embodiments of the present application, after the service controller receives the service request message including the message identifier, the service controller determines, based on the service request message, the target service component corresponding to the message identifier, determines the target service instance from the at least one service instance of the target service component, and sends the service request message to the target service instance, so that the target service instance processes the service request message. In this process, a network service can be provided for a user by using one service instance, and cooperation between a plurality of network elements is not required, so that a quantity of message exchange times is reduced, and time required for providing the network service for the user is shortened, thereby improving efficiency in providing the network service by the communications system for the user.

### BRIEF DESCRIPTION OF THE DRAWINGS

To describe the technical solutions in the embodiments of the present application more clearly, the following briefly describes the accompanying drawings required for describing the embodiments or the prior art. Apparently, the accompanying drawings in the following description show some embodiments of the present application, and persons of ordinary skill in the art may still derive other drawings from these accompanying drawings without creative efforts.

FIG. 1 is a diagram of a network architecture of a communications system according to the present application;

FIG. 2 is a schematic structural diagram 1 of a communications system according to the present application;

FIG. 3 is a schematic structural diagram 2 of a communications system according to the present application;

FIG. 4 is a flowchart of a network service implementation method according to the present application;

FIG. 5 is a schematic structural diagram 1 of a service controller according to the present application;

FIG. 6 is a schematic structural diagram 2 of a service controller according to the present application; and

FIG. 7 is a schematic diagram of a hardware structure of a service controller according to an embodiment of the present application.

### DETAILED DESCRIPTION

The following clearly describes the technical solutions in the embodiments of the present application with reference to the accompanying drawings in the embodiments of the present application. Apparently, the described embodiments are merely some but not all of the embodiments of the present application. All other embodiments obtained by persons of ordinary skill in the art based on the embodiments of the present application without creative efforts shall fall within the protection scope of the present application.

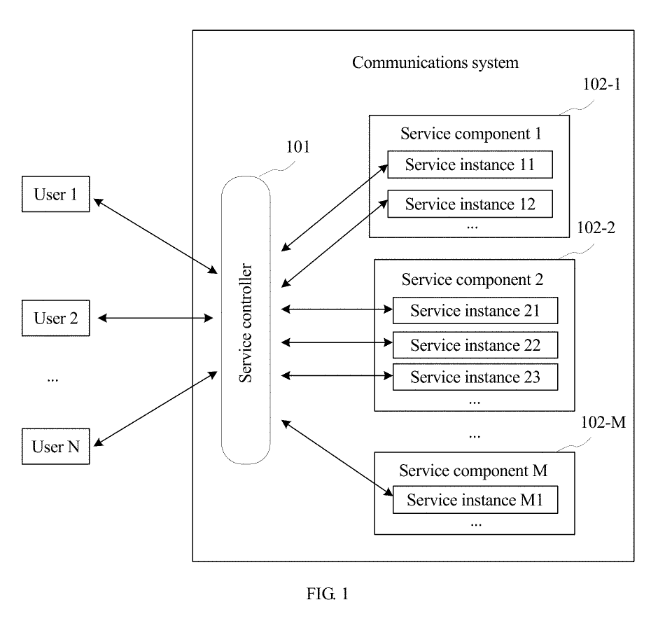

FIG. 1 is a diagram of a network architecture of a communications system according to the present application. Referring to FIG. 1, the communications system includes a service controller 101 and M service components (102-1 to 102-M), each service component corresponds to one network service, and one service component includes at least one service instance. A service instance of a service component may be obtained by deploying the service component in the communications system, and the service instance provides a corresponding network service for a user. A plurality of service instances of a same service component provide a same network service for the user. The plurality of service instances of the same service component may be deployed on a same hardware device, or may be deployed on different hardware devices. In an actual application process, when the user needs to obtain a network service from a network side, the user sends a service request to the service controller. The service controller forwards the service request to a corresponding service instance based on a type of the network service corresponding to the service request. The service instance processes the service request, to provide the corresponding network service for a client. The communications system, a network service implementation method, and a service controller provided in the present application are described below in detail by using specific embodiments.

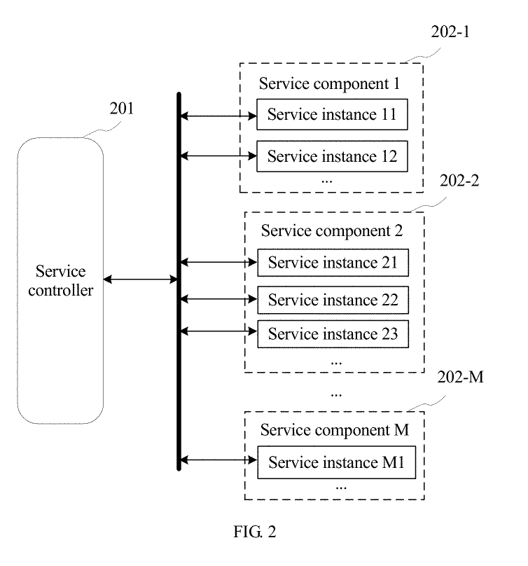

FIG. 2 is a schematic structural diagram 1 of a communications system according to the present application. Referring to FIG. 2, the communications system includes a service controller 201 and at least one service component (202-1 to 202-M), and each service component includes at least one service instance.

The service controller is configured to: receive a service request message including a message identifier; determine a target service component corresponding to the message identifier; determine a target service instance from at least one service instance of the target service component; and send the service request message to the target service instance. The service instance is configured to: receive the service request message sent by the service controller, and process the service request message.

In this embodiment of the present application, one service component corresponds to one network service, and each service component may be implemented by using software, or each service component may be implemented by using software and hardware. In an actual application process, to improve a rate of providing a service for a user, a plurality of service instances may be deployed in the communications system for each service component, and the plurality of service instances separately provide a network service for the user. For example, a service component 1 corresponds to a bearer management service. Three service instances of the service component 1 may be deployed in the communications system, and are respectively denoted as a service instance 1 to a service instance 3. The three service instances provide the bearer management service for the user. If the communications system can provide the bearer management service for 1000 users, the service instance 1 may provide the bearer management service for a user 1 to a user 300, the service instance 2 may provide the bearer management service for a user 301 to a user 750, and the service instance 3 may provide the bearer management service for a user 751 to a user 1000.

In this embodiment of the present application, the message identifier in the service request message may indicate a type of the request message. Optionally, the message identifier may be indicated by using a preset code identifier (for example, a protocol identification identifier). One network service corresponds to one service component, and one network service corresponds to one or more message identifiers.

For example, in a process in which a service control center provides a location management service for the user, messages exchanged between the user and the service control center may include a network attach request message and a network detach request message. A message identifier included in the network attach request message is message-001, and a message identifier included in the network detach request message is message-002. Then, if a service component corresponding to the network service is a service component 1, a correspondence among the location management service, the message identifiers, and the service component may be shown in Table 1. Certainly, in an actual application process, there may also be a one-to-one correspondence among a network service, a message identifier, and a service component, for example, a correspondence shown in Table 1 that is among a bearer management service, a message identifier, and a service component.

TABLE 1

| Network service | Message identifier | Service component |
|---|---|---|
| Location management | Message-001 | Service component 1 |
| service | | |
| Location management | Message-002 | Service component 1 |
| service | | |
| Bearer management service | Message-003 | Service component 2 |
| . . . | . . . | . . . |

The following describes in detail a working process of the communications system shown in the embodiment of FIG. 2.

When the user needs to obtain a network service in the communications system, the user sends a service request message including a message identifier to the service controller. After receiving the service request message, the service controller determines a target service component corresponding to the message identifier.

After determining that the target service component is obtained, the service controller obtains at least one service instance corresponding to the target service component, and determines a target service instance from the at least one service instance. Specifically, if the target service component corresponds to only one service instance, the service controller directly determines the service instance as the target service instance; or if the target service component corresponds to a plurality of (more than one) service instances, the service controller selects one service instance from the plurality of service instances as the target service instance. Optionally, the service controller may randomly select one service instance from the plurality of service instances as the target service instance, or may determine a service instance with highest idleness as the target service instance based on idleness of each service instance. It should be noted that in an actual application process, when the target service component corresponds to a plurality of (more than one) service instances, the target service instance may be further selected from the plurality of service instances by using another method. This is not specifically limited in the present application.

After determining that the target service instance is obtained from the at least one service instance corresponding to the target service component, the service controller forwards the received service request message to the target service instance. After the target service instance receives the service request message sent by the service controller, the target service instance processes the service request message, to provide a corresponding service for the user that sends the service request message.

The communications system provided in this embodiment of the present application includes a plurality of service components, each service component includes at least one service instance, and the service instance provides a network service for the user. In the system, a network service can be provided for the user by using one service instance, and cooperation between a plurality of network elements is not required, so that a quantity of message exchange times is reduced, and time required for providing the network service for the user is shortened, thereby improving efficiency in providing the network service by the communications system for the user. Further, when a network service in the communications system needs to be changed (for example, upgrading an existing network service or adding a new network service to the communications system), only a service component corresponding to the network service needs to be changed without a need to change processing logic of a plurality of network elements in the communications system and a procedure of interaction between the plurality of network elements. This process is simple and convenient, and reduces network service maintenance costs.

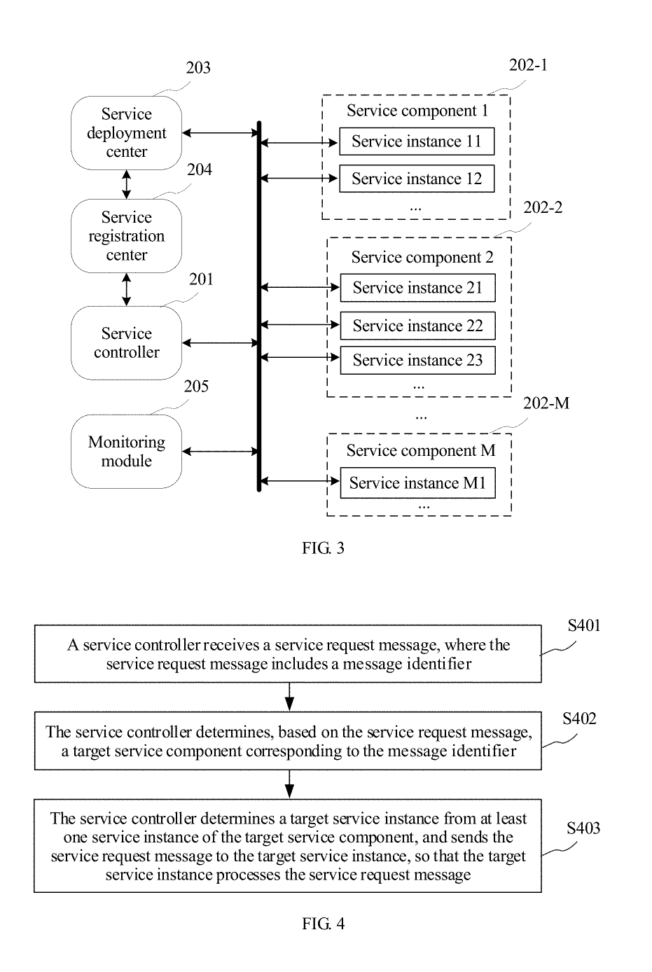

Based on the embodiment shown in FIG. 2, to facilitate maintenance of the communications system, a service deployment center and a service registration center may be added to the communications system. The following further describes the communications system by using an embodiment shown in FIG. 3.

FIG. 3 is a schematic structural diagram 2 of a communications system according to the present application. Based on the embodiment shown in FIG. 2, referring to FIG. 3, the communications system further includes a service deployment center 203 and a service registration center 204.

The service deployment center is configured to: determine a correspondence between a service component in the communications system and a message identifier, and send the correspondence to the service registration center. Correspondingly, the service registration center is configured to receive and store the correspondence sent by the service deployment center.

The service deployment center is further configured to: obtain a service requirement corresponding to each service component in the communications system, deploy at least one service instance for each service component in the communications system based on the service requirement corresponding to each service component, and send the service instance included in each service component and attribute information of each service instance to the service registration center. Correspondingly, the service registration center is configured to receive and store the service instance included in each service component and the attribute information of each service instance that are sent by the service deployment center, and the attribute information includes a network address of the service instance.

The following describes working processes of the service deployment center and the service registration center in detail.

When a new network service needs to be added to the communications system, the service deployment center obtains a service component corresponding to the network service that needs to be added, determines a correspondence between the service component and a message identifier of the network service, and sends the correspondence to the service registration center. When receiving the correspondence, the service registration center stores the correspondence.

After the service deployment center determines that the service component is obtained, the service deployment center obtains a network requirement for the network service in the communications system; determines, based on the network requirement, a quantity of service instances that need to be deployed in the communications system; deploys the corresponding quantity of service instances on a hardware device in the communications system; determines attribute information of each service instance, for example, a network address of the service instance; and sends a service instance included in each service component and the attribute information of each service instance to the service registration center. After receiving the service instance included in each service component and the attribute information of each service instance, the service registration center stores the service instance included in each service component and the attribute information of each service instance.

For example, when a network service (a location management service) needs to be added to the communications system, the service deployment center obtains a message identifier (network service 1) of the location management service and a service component 1 that can implement the location management service, determines a correspondence between the service component 1 and the network service 1, and sends the correspondence to the service registration center. The service registration center stores the correspondence.

If one service instance of the service component 1 can provide the location management service for 300 users, and the communications system has 1000 users, four service instances may be deployed in the communications system. The service deployment center may deploy the service component 1 on a hardware device 1 to obtain a service instance 1 and a service instance 2, deploy the service component 1 on a hardware device 2 to obtain a service instance 3 and a service instance 4, and separately obtain attribute information of the service instance 1 to the service instance 4, such as network addresses of the service instance 1 to the service instance 4. For example, the network address of the service instance 1 may be an IP address of the hardware device 1 and a port number of the service instance 1 on the hardware device 1. After completing deployment of the service component 1, the service deployment center sends, to the service registration center, the service instance 1 to the service instance 4 included in the service component 1 and the attribute information of the service instance 1 to the service instance 4. The service registration center stores the information.

After the service deployment center and the service registration center are added to the communications system, the service controller is specifically configured to: after the service controller receives the service request message including the message identifier, obtain the correspondence between a message identifier and a service component from the service registration center, and determine, based on the correspondence and the message identifier in the service request message, a target service component corresponding to the message identifier; and then obtain, from the service registration center, the at least one service instance included in the target service component, determine the target service instance from the at least one service instance, and send the service request message to the target service instance.

In an actual application process, the service deployment center may further add a service instance to an existing service component in the communications system, or delete a service instance, and the service deployment center may further change attribute information of an existing service instance, for example, change a network address of the service instance. After the service deployment center changes a service instance of a service component or attribute information of a service instance, the service deployment center sends a change notification to the service registration center, so that the service registration center changes the service instance of the service component or the attribute information of the service instance.

In an actual application process, to improve reliability of the communications system, a monitoring module 205 may be further deployed in the communications system, and the monitoring module 205 may be configured to: obtain a working status of the service instance in the communications system, and generate a fault notification message when the working status of the service instance is an abnormal state. Further, the monitoring module may further collect statistics of parameters such as a quantity of running times of each service instance and running duration of each service instance, to evaluate performance of the communications system.

FIG. 4 is a flowchart of a network service implementation method according to the present application. Referring to FIG. 4, the method may include the following steps:

S401. A service controller receives a service request message, where the service request message includes a message identifier.

S402. The service controller determines, based on the service request message, a target service component corresponding to the message identifier.

S403. The service controller determines a target service instance from at least one service instance of the target service component, and sends the service request message to the target service instance, so that the target service instance processes the service request message.

In this embodiment of the present application, there is a correspondence among a network service, a message identifier, and a service component. The correspondence is described in detail in the embodiment shown in FIG. 2, and details are not described herein again.

When a user needs to obtain a network service in a communications system, the user sends a service request message including a message identifier to a service controller, and the service controller determines, based on a correspondence between a message identifier and a service component, and the message identifier included in the service request message, a target service component corresponding to the message identifier. After determining that the target service component is obtained, the service controller obtains at least one service instance corresponding to the target service component, determines a target service instance from the at least one service instance, and forwards the received service request message to the target service instance. Optionally, the service controller may obtain a network address of the target service instance, and send the service request message to the target service instance based on the network address. The network address includes any one or any combination of the following: an Internet Protocol IP address, a Media Access Control MAC address, and a port number. After the target service instance receives the service request message sent by the service controller, the target service instance processes the service request message, to provide a corresponding service for the user that sends the service request message.

In the network service implementation method provided in this embodiment of the present application, after the service controller receives the service request message including the message identifier, the service controller determines, based on the service request message, the target service component corresponding to the message identifier, determines the target service instance from the at least one service instance of the target service component, and sends the service request message to the target service instance, so that the target service instance processes the service request message. In this process, a network service can be provided for the user by using one service instance, and cooperation between a plurality of network elements is not required, so that a quantity of message exchange times is reduced, and time required for providing the network service for the user is shortened, thereby improving efficiency in providing the network service by the communications system for the user.

Based on the embodiment shown in FIG. 4, when the user needs to obtain the network service, the user may need to exchange a message with a service instance for a plurality of times before obtaining the corresponding network service. In a process of obtaining one network service by the user, a service request message sent by the user to the service instance for a first time is a trigger message, and a service request message sent to the service instance for a time other than the first time is a process message. For example, if the user needs to exchange a message with a service instance 1 eight times before obtaining a network service 1, in a process of obtaining the network service 1 by the user by using the service instance 1, a message sent by the user to the service instance 1 at a first time is a trigger message, and all messages sent by the user to the service instance 1 at a second time to an eighth time are process messages.

In an actual application process, based on different service request message types (a trigger message or a process message), processes in which the service controller determines the target service instance from the at least one service instance of the target service component are also different. Specifically, there are the following two feasible implementations.

In a feasible implementation, a type of the service request message is a trigger message.

When the type of the service request message is a trigger message, the service controller determines any one of the at least one service instance as the target service instance; or the service controller obtains idleness of each of the at least one service instance, and determines a service instance with highest idleness as the target service instance.

In this feasible implementation, idleness of a service instance is a ratio of a remaining service capability of the service instance to a total service capability of the service instance. For example, the service instance can provide a network service for 100 users. If the service instance is currently providing the network service for 70 users, the service instance can further provide the network service for 30 users. In this case, the idleness of the service instance is 30%.

In this feasible implementation, the service request message may further include a terminal identifier. After the service controller determines that the target service instance is obtained, the service controller determines and stores a first correspondence among the terminal identifier, the target service component, and the target service instance.

For example, after receiving a service request message 1 whose service type is a trigger message, the service controller determines, as a service component 1, a target service component corresponding to a message identifier included in the service request message 1. The service component 1 includes three service instances, which are respectively denoted as a service instance 1 to a service instance 3. If a current idleness of the service instance 1 is 40%, a current idleness of the service instance 2 is 60%, and a current idleness of the service instance 3 is 45%, the service controller determines the service instance 2 with highest idleness as the target service instance. Further, the service controller may obtain a terminal identifier (terminal 1) included in the service request message 1, determine a first correspondence among the terminal 1, the service component 1, and the service instance 2, and store the correspondence.

In another feasible implementation, a type of the service request message is a process message.

When the type of the service request message is a process message, the service request message further includes a terminal identifier, and the service controller obtains a second correspondence among a terminal identifier, a service component, and a service instance, and determines the target service instance based on the second correspondence, the terminal identifier in the service request message, and the target service component.

In this feasible implementation, after the service controller determines that the target service instance is obtained, and sends the service request message to the target service instance, the service controller determines whether a network service ends. If a determining result is that the network service ends, the service controller removes, from the second correspondence, a correspondence among the terminal identifier in the service request message, the target service component, and the target service instance.

Optionally, whether the network service ends may be determined in the following manner: The service controller determines whether a process message having a same terminal identifier and a same message identifier as the service request message is received within preset duration, and if yes, determines that the network service ends. For example, it is assumed that a terminal identifier included in a service request message sent by a user to the service controller is terminal 1, and a message identifier is network service 1, so that the user obtains a network service 1. After the service controller sends a network service message to the target service instance, if the service controller does not receive, within preset duration (for example, 5 minutes), a process messageₒ including the terminal 1 and the network service 1, the service controller determines that the network service 1 ends.

For example, after receiving a service request message 2 whose service type is a process message, the service controller determines, as a service component 1, a target service component corresponding to a message identifier included in the service request message 2. Then, it is assumed that a terminal identifier included in the service request message 2 is terminal 2. The service controller obtains a second correspondence stored in the service controller that is among a terminal identifier, a service component, and a service instance, and determines, from the second correspondence based on the terminal identifier (terminal 2) and the service component (the service component 1), a service instance corresponding to the terminal 2 and the service component 1 as a target service instance.

In the foregoing two feasible implementations, optionally, for convenience of identifying the type of the service request message by the service controller, the service request message may include the type of the service request message.

In this embodiment of the present application, in a network service, a service instance generates data of a user in this network service during any message exchange between the user and the service instance, and data generated during previous message exchange in this network service may be used in subsequent message exchange. For example, in a process in which a service instance 1 provides a network service 1 for a user 1, the service instance 1 needs to exchange information with the user 1 five times before completing the network service 1. Data is generated in each information exchange between the service instance 1 and the user 1. When the service instance 1 exchanges information with the user 1 for a second time, data generated when the service instance 1 exchanges information with the user 1 for a first time may be used.

In this embodiment, the service controller determines the target service instance from the at least one service instance of the target service component in different manners based on different service request message types. In this way, it can be ensured that a same service instance provides a network service for a same user in a network service process, thereby avoiding a problem that a correct network service cannot be provided for the user due to a data loss caused when a plurality of service instances provide a network service for a same user in a network service process.

The following describes in detail the network service implementation method shown in this embodiment of the present application by using a specific example.

For example, it is assumed that a user 1 needs to obtain a network service 1 from the communications system, and the user 1 needs to exchange information with a service component corresponding to the network service 1 five times before obtaining the network service 1.

In a first information exchange process, the user 1 sends a service request message 1 to the service controller by using a terminal 1, and the service request message 1 includes a message identifier (network service 1) and a terminal identifier (terminal 1).

After receiving the service request message 1, the service controller determines the service request message 1 as a trigger message based on a message type in the service request message 1. The service controller determines a target service component corresponding to the network service 1 as a service component 1 based on the network service 1 and a correspondence between a message identifier and a service component, obtains three service instances of the service component 1, which are respectively denoted as a service instance 1 to a service instance 3, and obtains idle rates of the service instance 1 to the service instance 3. If idleness of the service instance 1 is 50%, idleness of the service instance 2 is 30%, and idleness of the service instance 3 is 60%, the service controller determines the service instance 3 with highest idleness as a target service instance.

After determining that the target service instance (the service instance 3) is obtained, the service controller sends the service request message 1 to the service instance 3, and the service instance 3 processes the service request message 1. The service controller records and stores a first correspondence among the terminal 1, the network service 1, and the service instance 3.

In a second information exchange process, the user 1 sends a service request message 2 to the service controller by using the terminal 1, and the service request message 2 includes a message identifier (network service 1), a terminal identifier (terminal 1), and a message type (process message).

After receiving the service request message 2, the service controller determines the service request message 2 as a process message based on the message type in the service request message 2. The service controller obtains, based on the stored first correspondence among the terminal 1, the network service 1, and the service instance 3, the target service instance (the service instance 3) corresponding to the terminal 1 and the network service 1, and sends the service request message 2 to the service instance 3. The service instance 3 processes the service request message 2. If the service controller determines that the network service 1 has not ended, the service controller does not delete the first correspondence.

It should be noted that a third information exchange process to a fifth information exchange process are similar to the second information exchange process, and details are not described herein again.

After the fifth information exchange process is performed, if the service controller determines that the network service 1 ends, the service controller deletes the first correspondence.

FIG. 5 is a schematic structural diagram 1 of a service controller according to the present application. The service controller is applied to a communications system, the communications system includes the service controller and at least one service component, one service component corresponds to one network service, and each service component includes at least one service instance. Referring to FIG. 5, the service controller includes:

a receiving module 501, configured to receive a service request message, where the service request message includes a message identifier;

a determining module 502, configured to: determine, based on the service request message, a target service component corresponding to the message identifier, and determine a target service instance from at least one service instance of the target service component; and a sending module 503, configured to send the service request message to the target service instance, so that the target service instance processes the service request message.

In an actual application process, when a type of the service request message is a trigger message, the trigger message is a message for triggering a network service, and the determining module 502 may be specifically configured to:

determine any one of the at least one service instance as the target service instance; or

obtain idleness of each of the at least one service instance, and determine a service instance with highest idleness as the target service instance.

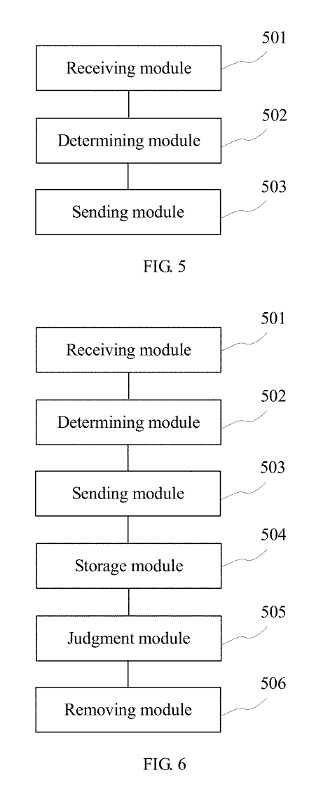

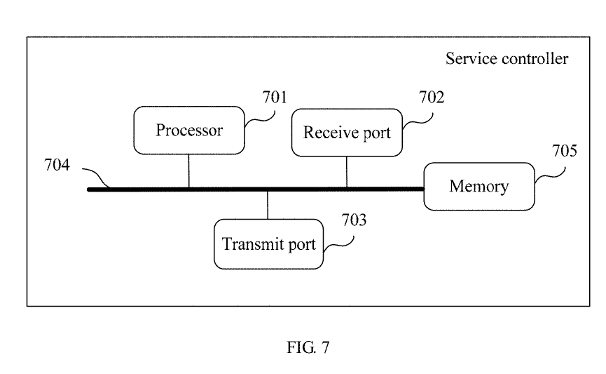

FIG. 6 is a schematic structural diagram 2 of a service controller according to the present application. Based on the embodiment shown in FIG. 5, referring to FIG. 6, the service controller may further include a storage module 504.

The determining module 502 may be further configured to determine a first correspondence among a terminal identifier, the target service component, and the target service instance after the sending module 503 sends the service request message to the target service instance. The service request message further includes the terminal identifier.

The storage module 504 is configured to store the first correspondence among the terminal identifier, the target service component, and the target service instance.

In an actual application process, when a type of the service request message is a process message, the process message is a message that is sent by a user after the user sends a trigger message and that is used to obtain a network service, the service request message further includes a terminal identifier, and the determining module 502 may be further specifically configured to:

obtain a second correspondence among a terminal identifier, a service component, and a service instance; and

determine the target service instance based on the second correspondence, the terminal identifier in the service request message, and the target service component.

Further, the service controller may further include a judgment module 505 and a removing module 506.

The judgment module 505 is configured to: after the sending module sends the service request message to the target service instance, determine whether the network service ends.

The removing module 506 is configured to remove, from the second correspondence, a correspondence among the terminal identifier in the service request message, the target service component, and the target service instance when the judgment module determines that the network service ends.

Optionally, the sending module 503 may be specifically configured to:

obtain a network address of the target service instance, where the network address includes any one or any combination of the following: an Internet Protocol IP address, a Media Access Control MAC address, and a port number; and

send the service request message to the target service instance based on the network address.

The service controller described in this embodiment of the present application may execute the technical solutions shown in the foregoing method embodiment, implementation principles and beneficial effects thereof are similar, and details are not described herein again.

FIG. 7 is a schematic diagram of a hardware structure of a service controller according to an embodiment of the present application. Referring to FIG. 7, the service controller includes a processor 701, a receive port 702, a transmit port 703, a communications bus 704, and a memory 705. The communications bus 704 is configured to implement communication connection between components, the memory 705 may store various programs, and the processor 701 completes various processing functions and implements method steps in this embodiment by executing the programs stored in the memory 705. Specifically:

The processor 701 receives a service request message by using the receive port 702, and the service request message includes a message identifier.

The processor 701 determines, based on the service request message, a target service component corresponding to the message identifier, and determines a target service instance from at least one service instance of the target service component.

The processor 701 sends the service request message to the target service instance by using the transmit port 703, so that the target service instance processes the service request message.

In an actual application process, when a type of the service request message is a trigger message, the processor 701 may specifically determine the target service instance from the at least one service instance in the following feasible implementation:

determining any one of the at least one service instance as the target service instance; or

obtaining idleness of each of the at least one service instance, and determining a service instance with highest idleness as the target service instance.

In an actual application process, after sending the service request message to the target service instance by using the transmit port 703, the processor 701 further determines a first correspondence among a terminal identifier, the target service component, and the target service instance, and the service request message further includes the terminal identifier.

The processor 701 stores, in the memory 705, the first correspondence among the terminal identifier, the target service component, and the target service instance.

In an actual application process, when a type of the service request message is a process message, the processor 701 may specifically determine the target service instance from the at least one service instance in the following feasible implementation:

obtaining a second correspondence among a terminal identifier, a service component, and a service instance; and

determining the target service instance based on the second correspondence, a terminal identifier in the service request message, and the target service component.

Further, after sending the service request message to the target service instance by using the transmit port 703, the processor 701 further determines whether a network service ends.

When determining that the network service ends, the processor 701 removes, from the second correspondence, a correspondence among the terminal identifier in the service request message, the target service component, and the target service instance.

Optionally, the processor 701 may send the service request message to the target service instance in the following feasible implementation. Specifically, the processor 701 obtains a network address of the target service instance, and sends the service request message to the target service instance based on the network address. The network address includes any one or any combination of the following: an Internet Protocol IP address, a Media Access Control MAC address, and a port number.

The service controller described in this embodiment of the present application may execute the technical solutions shown in the foregoing method embodiment, implementation principles and beneficial effects thereof are similar, and details are not described herein again.

Persons of ordinary skill in the art may understand that all or some of the steps of the method embodiment may be implemented by a program instructing relevant hardware. The program may be stored in a computer readable storage medium. When the program runs, the steps of the method embodiment are performed. The foregoing storage medium includes: any medium that can store program code, such as a ROM, a RAM, a magnetic disk, or an optical disc.

Finally, it should be noted that the foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present application.

What is claimed is:

1. A network service implementation method, applied to a communications system, wherein the communications system comprises a service controller and at least one service component, one service component corresponding to one network service, and each service component comprises at least one service instance, the method comprising:
receiving, by the service controller, a service request message comprising a message identifier;
determining, by the service controller based on the service request message, a target service component corresponding to the message identifier;
determining, by the service controller, a target service instance from at least one service instance of the target service component; and
sending, by the service controller, the service request message to the target service instance to enable the target service instance to process the service request message.

2. The method according to claim 1, wherein:
a type of the service request message is a trigger message for triggering a network service; and
determining, by the service controller, a target service instance from at least one service instance of the target service component comprises:
determining, by the service controller, any one of the at least one service instance as the target service instance, or
obtaining, by the service controller, idleness of each of the at least one service instance, and determining a service instance with highest idleness as the target service instance.

3. The method according to claim 2, wherein the service request message further comprises a terminal identifier, and after the sending, by the service controller, the service request message to the target service instance, the method further comprises:
determining and storing, by the service controller, a first correspondence among the terminal identifier, the target service component, and the target service instance.

4. The method according to claim 1, wherein:
a type of the service request message is a process message that is sent by a user after the user sends a trigger message for obtaining a network service, and wherein the service request message further comprises a terminal identifier; and
determining, by the service controller, a target service instance from at least one service instance of the service component comprises:
obtaining, by the service controller, a second correspondence among a terminal identifier, a service component, and a service instance; and
determining, by the service controller, the target service instance based on the second correspondence, the terminal identifier in the service request message, and the target service component.

5. The method according to claim 4, wherein after sending, by the service controller, the service request message to the target service instance, the method further comprises:
determining, by the service controller, whether the network service ends; and
removing, by the service controller from the second correspondence, a correspondence among the terminal identifier in the service request message, the target service component, and the target service instance when a determining result is that the network service ends.

6. The method according to claim 1, wherein sending, by the service controller, the service request message to the target service instance comprises:
obtaining, by the service controller, a network address of the target service instance, wherein the network address comprises any one or any combination of the following: an Internet Protocol (IP) address, a Media Access Control (MAC) address, and a port number; and
sending, by the service controller, the service request message to the target service instance based on the network address.

7. A service controller, comprising:
a receiver configured to receive a service request message comprising a message identifier;
a processor configured to:
determine, based on the service request message, a target service component corresponding to the message identifier, and
determine a target service instance from at least one service instance of the target service component; and
a transmitter configured to send the service request message to the target service instance to enable the target service instance to process the service request message.

8. The service controller according to claim 7, wherein:
a type of the service request message is a trigger message for triggering a network service; and
the processor is configured to:
determine any one of the at least one service instance as the target service instance; or
obtain idleness of each of the at least one service instance, and determine a service instance with highest idleness as the target service instance.

9. The service controller according to claim 8, wherein:
the processor further configured to determine a first correspondence among a terminal identifier, the target service component, and the target service instance after the transmitter sends the service request message to the target service instance, and wherein the service request message further comprises the terminal identifier; and
the service controller further comprises memory configured to store the first correspondence among the terminal identifier, the target service component, and the target service instance.

10. The service controller according to claim 7, wherein:
a type of the service request message is a process message that is sent by a user after the user sends a trigger message for obtaining a network service, and wherein the service request message further comprises a terminal identifier; and
the processor is further configured to:
obtain a second correspondence among a terminal identifier, a service component, and a service instance; and
determine the target service instance based on the second correspondence, the terminal identifier in the service request message, and the target service component.

11. The service controller according to claim 7, wherein the transmitter is configured to:
obtain a network address of the target service instance, wherein the network address comprises any one or any combination of the following: an Internet Protocol (IP) address, a Media Access Control (MAC) address, and a port number; and
send the service request message to the target service instance based on the network address.

12. A service controller, comprising:
a transmit port;
a receive port; and
a processor configured to:
receive a service request message by using the receive port, wherein the service request message comprises a message identifier;
determine, based on the service request message, a target service component corresponding to the message identifier, and determine a target service instance from at least one service instance of the target service component; and
send the service request message to the target service instance by using the transmit port to enable the target service instance to process the service request message.

13. The service controller according to claim 12, wherein:
a type of the service request message is a trigger message for triggering a network service; and
the processor is further configured to:
determine any one of the at least one service instance as the target service instance, or
obtain idleness of each of the at least one service instance, and determine a service instance with highest idleness as the target service instance.

14. The service controller according to claim 13, wherein the processor is further configured to:
determine a first correspondence among a terminal identifier, the target service component, and the target service instance after the processor sends the service request message to the target service instance by using the transmit port, and wherein the service request message further comprises the terminal identifier; and
store the first correspondence among the terminal identifier, the target service component, and the target service instance.

15. The service controller according to claim 12, wherein:
a type of the service request message is a process message that is sent by a user after the user sends a trigger message for obtaining a network service, wherein the service request message further comprises a terminal identifier; and
the processor is further configured to:
obtain a second correspondence among a terminal identifier, a service component, and a service instance; and
determine the target service instance based on the second correspondence, the terminal identifier in the service request message, and the target service component.

16. The service controller according to claim 15, wherein the processor is further configured to:
after the processor sends the service request message to the target service instance by using the transmit port, determine whether the network service ends; and
remove, from the second correspondence, a correspondence among the terminal identifier in the service request message, the target service component, and the target service instance when the processor determines that the network service ends.

17. The service controller according to claim 12, wherein the processor is further configured to:
obtain a network address of the target service instance, wherein the network address comprises any one or any combination of the following: an Internet Protocol (IP) address, a Media Access Control (MAC) address, and a port number; and
send the service request message to the target service instance based on the network address by using the transmit port.

18. A communications system, comprising:
at least one service component comprising at least one service instance, wherein one service component corresponds to one network service;
a service controller configured to:
receive a service request message comprising a message identifier,
determine a target service component corresponding to the message identifier,
determine a target service instance from at least one service instance of the target service component, and
send the service request message to the target service instance; and
wherein the service instance is configured to: receive the service request message sent by the service controller, and process the service request message.

19. The system according to claim 18, further comprising:
a service deployment center configured to: determine a correspondence between a service component in the communications system and a message identifier, and send the correspondence to a service registration center;
wherein the service registration center is configured to: receive and store the correspondence sent by the service deployment center; and
wherein the service controller is configured to:
receive the service request message comprising the message identifier,
obtain the correspondence from the service registration center,
determine, based on the correspondence, the target service component corresponding to the message identifier,
determine the target service instance from the at least one service instance of the target service component, and
send the service request message to the target service instance.

20. The system according to claim 19, wherein:
the service deployment center is further configured to:
obtain a service requirement corresponding to each service component in the communications system,
deploy, in the communications system based on the service requirement corresponding to each service component, the at least one service instance for each service component, and
send the service instance comprised in each service component and attribute information of each service instance to the service registration center, wherein the attribute information comprises a network address of the service instance;
the service registration center is further configured to:
receive and store the service instance comprised in each service component and the attribute information of each service instance that are sent by the service deployment center; and
correspondingly, the service controller is further configured to:
receive the service request message comprising the message identifier,
obtain the correspondence from the service registration center; determine, based on the correspondence, the target service component corresponding to the message identifier,
obtain, from the service registration center, the at least one service instance comprised in the target service component,
determine the target service instance from the at least one service instance, and
send the service request message to the target service instance.
